(19) United States
(12) Patent Application Publication
(10) Pub. No.: US 2024/0227129 A9
(43) Pub. Date: Jul. 11, 2024

(54) Multi-functional screwdriver structure

(71) Applicant: Huang Ting Ya, Taichung City 427 (TW)

(72) Inventor: Huang Ting Ya, Taichung City 427 (TW)

(21) Appl. No.: 17/971,603

(22) Filed: Oct. 23, 2022

(51) Int. Cl. B25B 15/00; B25B 15/02; B25B 23/00

(52) U.S. Cl. CPC B25B 15/001; B25B 15/02; B25B 23/0028

(57) ABSTRACT

A multi-functional screwdriver structure contains a body, a grip, a receiving chamber, a cap, an accommodation sleeve, multiple sockets, a shank, and a movable connector formed on a front end of the shank and connected with an orifice of a first screwdriver bit by using a screw bolt. The first screwdriver bit includes a square socket joint extending from a front end thereof, and the first screwdriver bit includes a hexagonal hole defined on a front end of the square socket joint. A bit holder is connected on a front end of the grip and is configured to receive the shank in a center of the bit holder, and the bit holder includes multiple apertures defined around the center thereof and configured to accommodate multiple second screwdriver bits.

### FIELD OF THE INVENTION

The present invention relates to a multi-functional screwdriver structure which is capable of accommodating the first screwdriver bits, the multiple second screwdriver bits and the multiple sockets simultaneously so as to fix or remove the various objects based on using requirements.

### BACKGROUND OF THE INVENTION

A conventional screwdriver contains an accommodation chamber defined in a middle section thereof, a bit holder received in the accommodation chamber, and a cap connected below the accommodation groove, wherein the bit holder is configured to receive multiple screwdriver bits of various sizes and types.

As desiring to replace one of the multiple screwdriver bits, the cap is removed so as to detach the one screwdriver bit from the bit holder, then the one screwdriver bit is connected on a shank of the screwdriver.

However, such replacement of the one screwdriver bit is troublesome. The bit holder is not connected with the screwdriver, so it is easy to lose. Also, the bit holder is merely configured to accommodate the multiple screwdriver bits, thus the screwdriver cannot not receive and replace sockets.

The present invention has arisen to mitigate and/or obviate the afore-described disadvantages.

### SUMMARY OF THE INVENTION

The primary objective of the present invention is to provide a multi-functional screwdriver structure which is capable of accommodating the first screwdriver bits, the multiple second screwdriver bits and the multiple sockets simultaneously so as to fix or remove the various objects based on using requirements.

To obtain above-mentioned aspect, a multi-functional screwdriver structure provided by the present invention contains: a body, a grip extending on the body, a receiving chamber defined in the grip, a cap screwed on a rear end of the grip, an accommodation sleeve accommodated in the receiving chamber of the grip and covered by the cap, multiple sockets received in the accommodation sleeve, a shank extending from a front end of the grip, and a movable connector formed on a front end of the shank and connected with an orifice of a first screwdriver bit by using a screw bolt.

The first screwdriver bit includes a square socket joint extending from a front end thereof, and the first screwdriver bit includes a hexagonal hole defined on a front end of the square socket joint.

A bit holder is connected on the front end of the grip and is configured to receive the shank in a center of the bit holder, and the bit holder includes multiple apertures defined around the center thereof and configured to accommodate multiple second screwdriver bits.

Preferably, the accommodation sleeve has multiple openings defined thereon and configured to remove the multiple sockets easily.

Preferably, the square socket joint of the first screwdriver bit is configured to accommodate one of the multiple sockets which is removed from the accommodation sleeve.

Preferably, the hexagonal hole is configured to receive one of the multiple second screwdriver bits which is removed from one of the multiple apertures of the bit holder.

Preferably, the first screwdriver bit is rotatable within 180 degrees along the orifice and the screw bolt to fix or remove various objects rotatably.

### BRIEF DESCRIPTION OF THE DRAWINGS

FIG. 1 is a perspective view showing the assembly of a multi-functional screwdriver structure according to a preferred embodiment of the present invention.

FIG. 2 is a perspective view showing the exploded components of the multi-functional screwdriver structure according to the preferred embodiment of the present invention.

FIG. 3 is a cross sectional view showing the assembly of a part of the multi-functional screwdriver structure according to the preferred embodiment of the present invention.

FIG. 4 is a perspective view showing the exploded components of a part of the multi-functional screwdriver structure according to the preferred embodiment of the present invention.

FIG. 5 is a perspective view showing the operation of the multi-functional screwdriver structure according to the preferred embodiment of the present invention.

FIG. 6 is another perspective view showing the operation of the multi-functional screwdriver structure according to the preferred embodiment of the present invention.

FIG. 7 is a side plan view showing the operation of the multi-functional screwdriver structure according to the preferred embodiment of the present invention.

### DETAILED DESCRIPTION OF THE PREFERRED EMBODIMENTS

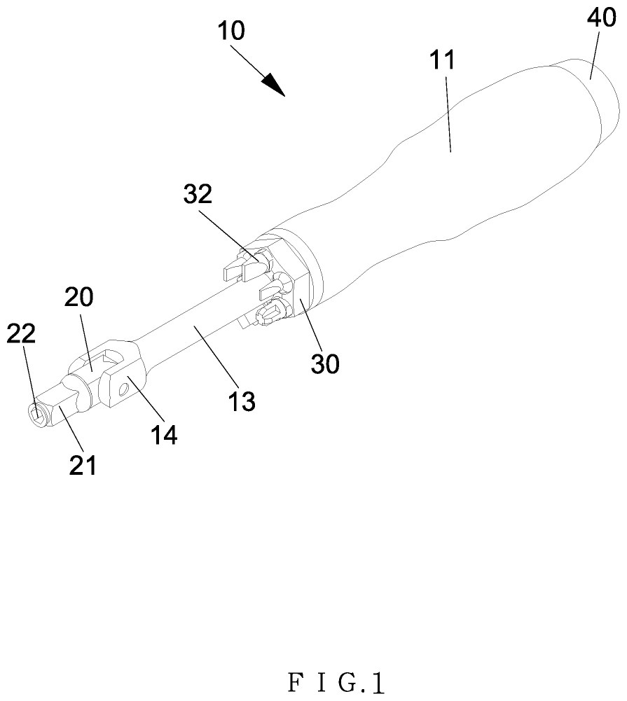

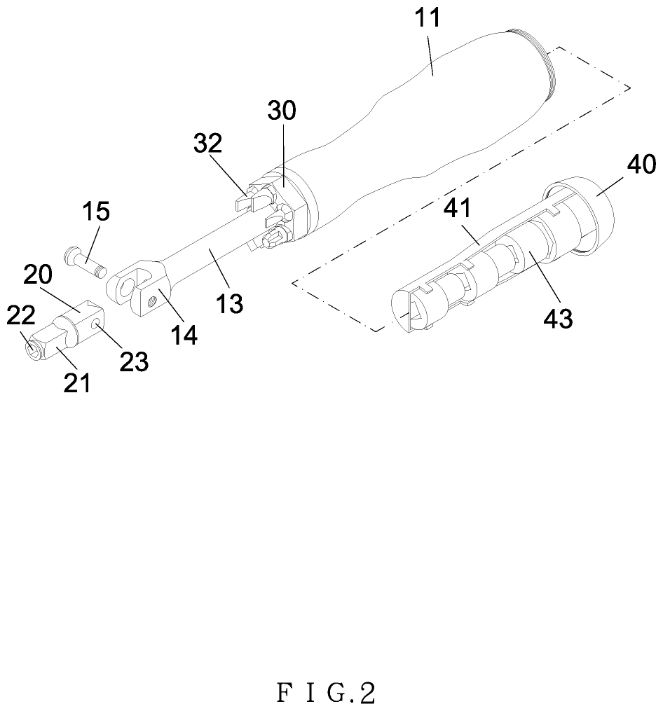

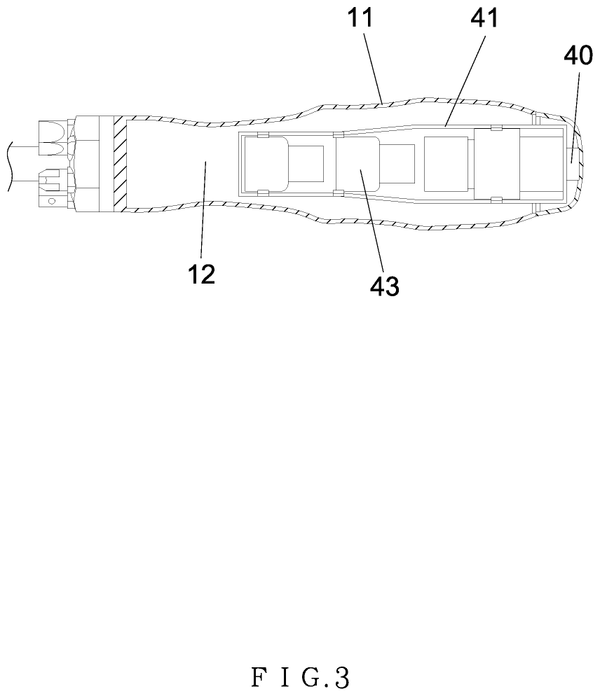

With reference to FIGS. 1-3, a multi-functional screwdriver structure according to a preferred embodiment of the present invention comprises: a body 10, a grip 11 extending on the body 10, a receiving chamber 12 defined in the grip 11, a cap 40 screwed on a rear end of the grip 11, an accommodation sleeve 41 accommodated in the receiving chamber 12 of the grip 11 and covered by the cap 40, multiple sockets 43 received in the accommodation sleeve 41, a shank 13 extending from a front end of the grip 11, and a movable connector 14 formed on a front end of the shank 13 and connected with an orifice 23 of a first screwdriver bit 20 by using a screw bolt 15.

The first screwdriver bit 20 includes a square socket joint 21 extending from a front end thereof, and the first screwdriver bit 20 includes a hexagonal hole 22 defined on a front end of the square socket joint 21.

A bit holder 30 is connected on the front end of the grip 11 and is configured to receive the shank 13 in a center of the bit holder 30, and the bit holder 30 includes multiple apertures 31 defined around the center thereof and configured to accommodate multiple second screwdriver bits 32.

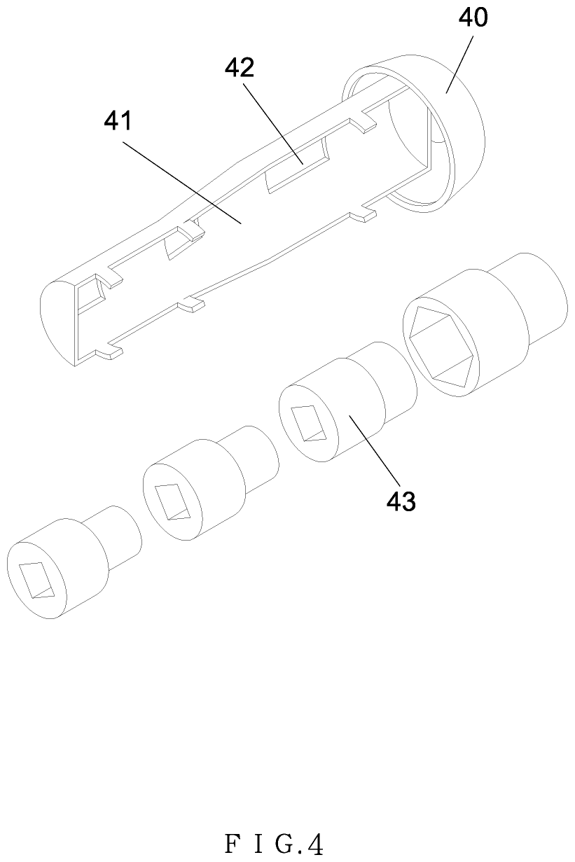

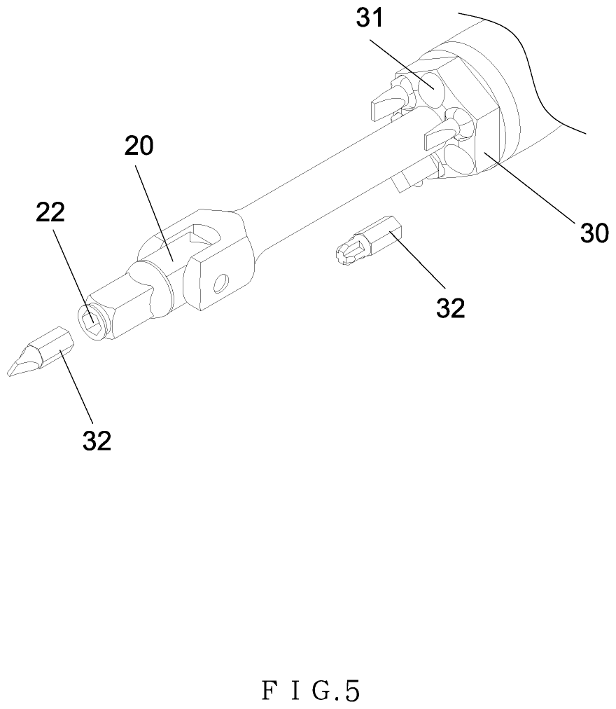

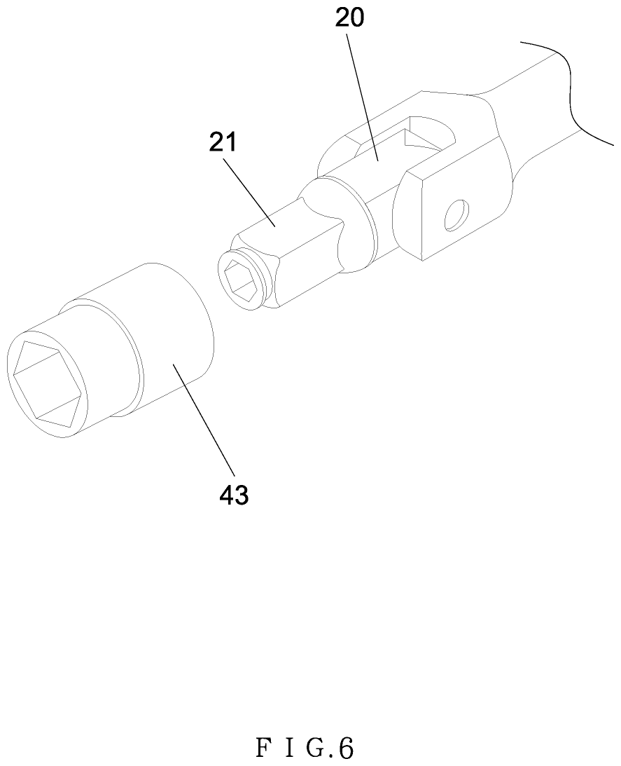

Referring to FIGS. 4-6, the accommodation sleeve 41 has multiple openings 42 defined thereon and configured to remove the multiple sockets 43 easily, wherein the square socket joint 21 of the first screwdriver bit 20 is configured to accommodate one of the multiple sockets 43 which is removed from the accommodation sleeve 41, and the hexagonal hole 22 is configured to receive one of the multiple second screwdriver bits 32 which is removed from one of the multiple apertures 31 of the bit holder 30.

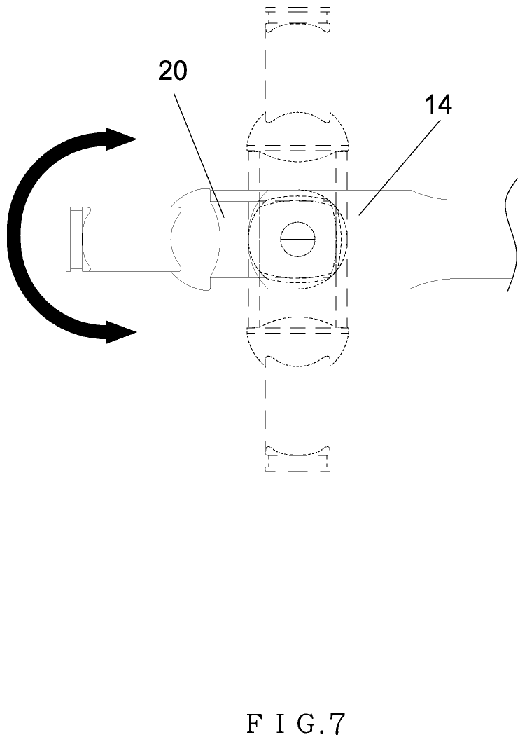

As shown in FIG. 7, the first screwdriver bit 20 is rotatable within 180 degrees along the orifice 23 and the screw bolt 15 to fix or remove various objects (not shown) rotatably.

Thereby, the multi-functional screwdriver structure is capable of accommodating the first screwdriver bits, the multiple second screwdriver bits and the multiple sockets simultaneously so as to fix or remove the various objects based on using requirements.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A multi-functional screwdriver structure comprising:
a body, a grip extending on the body, a receiving chamber defined in the grip, a cap screwed on a rear end of the grip, an accommodation sleeve accommodated in the receiving chamber of the grip and covered by the cap, multiple sockets received in the accommodation sleeve, a shank extending from a front end of the grip, and a movable connector formed on a front end of the shank and connected with an orifice of a first screwdriver bit by using a screw bolt;
wherein the first screwdriver bit includes a square socket joint extending from a front end thereof, and the first screwdriver bit includes a hexagonal hole defined on a front end of the square socket joint;
wherein a bit holder is connected on the front end of the grip and is configured to receive the shank in a center of the bit holder, and the bit holder includes multiple apertures defined around the center thereof and configured to accommodate multiple second screwdriver bits.

2. The multi-functional screwdriver structure as claimed in claim 1, wherein the accommodation sleeve has multiple openings defined thereon and configured to remove the multiple sockets easily.

3. The multi-functional screwdriver structure as claimed in claim 1, wherein the square socket joint of the first screwdriver bit is configured to accommodate one of the multiple sockets which is removed from the accommodation sleeve.

4. The multi-functional screwdriver structure as claimed in claim 1, wherein the hexagonal hole is configured to receive one of the multiple second screwdriver bits which is removed from one of the multiple apertures of the bit holder.

5. The multi-functional screwdriver structure as claimed in claim 1, wherein the first screwdriver bit is rotatable within 180 degrees along the orifice and the screw bolt to fix or remove various objects rotatably.
